(19) United States
(12) Patent Application Publication
(10) Pub. No.: US 2006/0279706 A1
(43) Pub. Date: Dec. 14, 2006

(54) Projection system

(76) Inventors: Cullen E. Bash, San Francisco, CA (US); Chandrakant D. Patel, Fremont, CA (US); John M. Koegler III, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/152,527

(22) Filed: Jun. 14, 2005

(51) Int. Cl. G03B 21/18

(52) U.S. Cl. 353/54

(57) ABSTRACT

A projection system has at least one heat source. A closed-loop heat pipe has at least one heat receiving portion thermally coupled with the at least one heat source, and at least one heat rejecting portion thermally coupled with a heat sink. A heat carrying fluid circulating through the heat pipe receives heat from the at least one heat source and releases heat to the heat sink.

### BACKGROUND

Projection systems are being provided with more powerful light sources to project a sharper and brighter image. However, powerful light sources also generate large amounts of heat. A significant problem associated with projection systems is that of dissipating heat. Heat must be dissipated so that temperatures of projection system components will not exceed suitable operating temperatures and cause deterioration of the projection system performance or damage to components of the projection system. Current projection system cooling solutions typically rely on fans to circulate air through the projector and remove the heat. However, air circulation fans are generally undesirable because they are noisy, and the noise generated by the fans reduces the perceived quality of the presentation. The elimination or reduction in the number of cooling fans is highly desirable. It would be desirable to have a projection system having thermal management features for effectively and quietly cooling the heat dissipating components housed within the projection system.

### SUMMARY

One embodiment of the present invention provides a projection system comprising at least one heat source within the projection system and a closed-loop heat pipe having at least one heat receiving portion and at least one heat rejecting portion. The at least one heat receiving portion is thermally coupled with the at least one heat source, and the at least one heat rejecting portion is thermally coupled with a heat sink. A heat carrying fluid circulating through the heat pipe receives heat from the at least one heat source and releases heat to the heat sink.

### BRIEF DESCRIPTION OF THE DRAWINGS

FIG. 1 is a block diagram illustrating a digital projection system having a closed-loop heat pipe according to one embodiment of the present invention.

FIG. 2A is a schematic illustration of the closed-loop heat pipe of FIG. 1 as a pulsating heat pipe having one evaporator according to one embodiment of the present invention.

FIG. 2B is a schematic illustration of the closed-loop heat pipe of FIG. 1 as a pulsating heat pipe having more than one evaporator according to one embodiment of the present invention.

FIG. 3 is a schematic illustration of the closed-loop heat pipe of FIG. 1 as a miniature loop heat pipe according to one embodiment of the present invention.

FIG. 4A is a schematic illustration of the closed-loop heat pipe of FIG. 1 as a loop thermosiphon having one evaporator according to one embodiment of the present invention.

FIG. 4B is a schematic illustration of the closed-loop heat pipe of FIG. 1 as a loop thermosiphon having more than one evaporator according to one embodiment of the present invention.

### DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

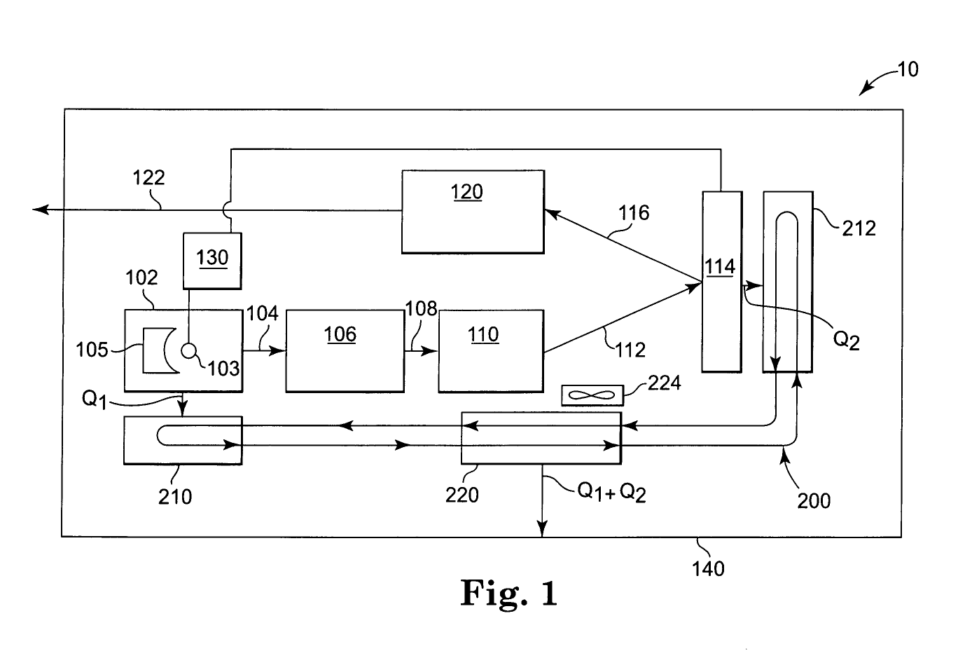

FIG. 1 is a block diagram illustrating one embodiment of a projection system 10. In projection system 10, an illumination source 102 generates and emits an illumination beam to an illumination relay 106 along an illumination path 104. Illumination source 102 includes a light source lamp 103 and a reflector 105 for reflecting light emitted from light source lamp 103 toward illumination relay 106. Light source lamp 103 may be a high pressure mercury lamp, xenon lamp, halogen lamp, metal halide lamp, or other suitable projector lamp that provides a monochromatic or polychromatic illumination beam.

Illumination relay 106 integrates and collimates the illumination beam and provides the illumination beam to a lens system 110 along an illumination path 108. Lens system 110 directs and focuses the illumination beam onto modulation device 114 along an illumination path 112. Illumination relay 106 images illumination source 102 onto modulation device 114 via lens system 110 such that modulation device 114 is uniformly illuminated with minimum overfill.

Modulation device 114 modulates the illumination beam from lens system 110 according to an image input signal, e.g., a computer or video input signal (not shown) to form an imaging beam. Modulation device 114 comprises at least one digital modulator such as a spatial light modulator such as liquid crystal on silicon (LCOS), liquid crystal display (LCD), digital micromirror display (DMD) or other suitable type. In one embodiment, modulation device 114 includes a separate digital modulator for each color, e.g., red, blue, and green. Selected portions of the illumination beam are reflected or transmitted from modulation device 114 along an optical path 116 to a projection lens 120. In some embodiments, additional lens systems (not shown) may be positioned between modulation device 114 and projection lens 120. Projection lens 120 focuses and may zoom the imaging beam along an optical path 122 to cause still or video images to be formed on a screen or other display surface. Projection lens 120 images modulation device 114 onto the screen or other display surface used for final display.

During operation of projection system 10, there are a plurality of heat sources within projection system 10. As used herein, a heat source within projection system 10 is any component requiring the dissipation of heat. A heat source may generate heat by its operation (such as light source lamp 103), or may be heated by an external source. For example, the high intensity light emitted light source lamp 103 increases the temperature of components along the illumination path, including reflector 105, illumination relay 106, lens system 110, modulation device 114 and projection lens 120. Other electronic components of projection system 10 also are heat sources within projection system 10, including for example, modulation device 114 and a power supply 130 powering light source lamp 103 and modulation device 114. Electronic components such as memory devices and DVD readers may also serve as heat sources within projection system 10.

To remove heat from projection system 10, a closed-loop heat pipe 200 is thermally coupled between at least one of the heat sources within projection system 10 and a heat sink. A heat carrying working fluid circulates through closed-loop heat pipe 200, receiving a heat load Q from one or more of the heat sources within projection system 10 and carrying the heat to heat sink where the heat load Q is released. In one embodiment, closed-loop heat pipe 200 has at least one heat receiving portion and at least one heat rejecting portion. Each heat receiving portion is thermally coupled with a heat source via an evaporator, and each heat rejecting portion is thermally coupled with heat sink via a condenser. As used herein, a heat sink is any material, device or environment capable of absorbing heat. In one embodiment, the heat sink is attached to or otherwise a part of the condenser. In one embodiment, the heat sink comprises a chassis 140 of projection system 10. In one embodiment, the heat sink comprises ambient air of the environment surrounding projection system 10.

In FIG. 1, heat pipe 200 includes a first evaporator 210 receiving heat load Q₁, a second evaporator 212 receiving heat load Q₂, and a condenser 220 releasing heat load Q₁+Q₂. Evaporators 210, 212 and condenser 220 are of any suitable design and shape that correspond best to the heat transfer conditions, and facilitate heat transfer by radiation, convection, conduction or any combination thereof. In one embodiment, an air mover 224 is be positioned to direct air over condenser 220 and thereby aid in cooling condenser 220 and the working fluid therein. In some embodiments, condenser 220 includes one or more fins to further facilitate heat transfer. The closed loop heat pipe 200 is configured such that heat from the heat sources evaporates liquid working fluid from a stream of liquid working fluid within its respective evaporator 210, 212 to produce a stream of working fluid vapor. The stream of working fluid vapor condenses in the condenser 220 to release heat to the heat sink and return to the stream of liquid working fluid.

The heat carrying working fluid comprises any suitable working fluid, including but not limited to water, acetone, alcohol, CFC, HCFC and HFC refrigerants, Fluorinert™ electronic liquids and Novec™ engineered fluids, both available from 3M Company of Saint Paul, Minn., USA, or any other fluid suitable for two-phase heat transfer. The heat carrying working fluid is further selected to be compatible with the materials forming heat pipe 200.

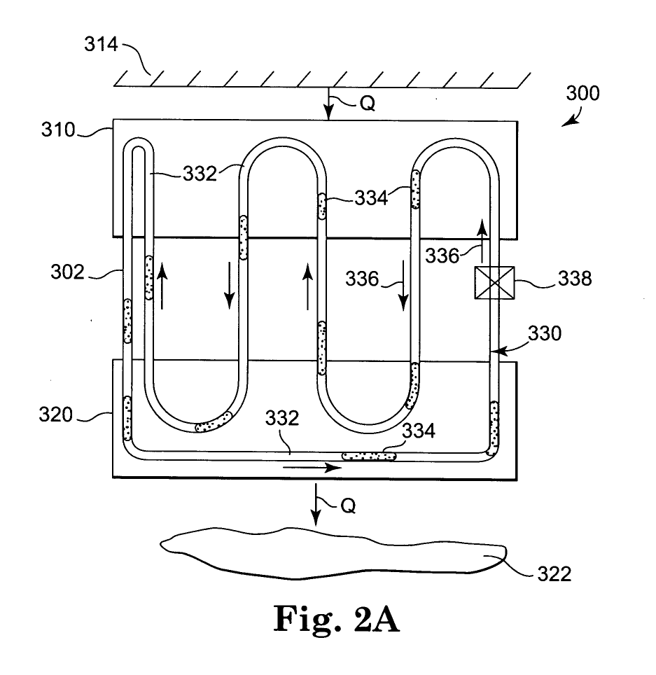

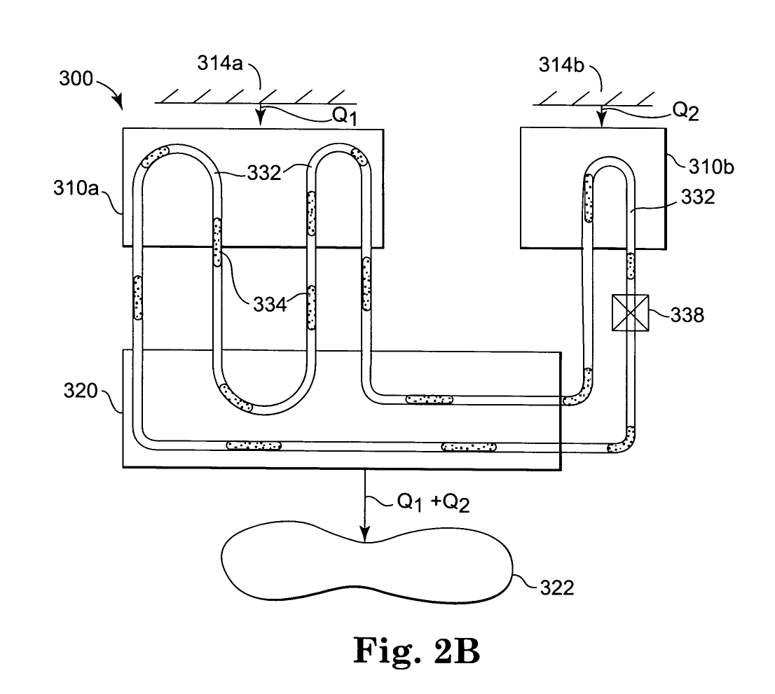

In one embodiment, closed-loop heat pipe 200 comprises a closed-loop pulsating heat pipe. Referring to FIG. 2A, closed-loop pulsating heat pipe 300 comprises a capillary tube 302 undulating back and forth between an evaporator 310 (thermally coupled to heat source 314 to receive heat load Q) and a condenser 320 (thermally coupled to heat sink 322 to release heat load Q). Capillary tube 302 is filled with a working fluid 330 distributed throughout capillary tube 302 in the form of liquid slugs 332 and vapor bubbles 334. The pulsating heat pipe 300 utilizes a temperature gradient between evaporator 310 and condenser 320 to circulate the two-phase working fluid 330 through capillary tube 302 and thereby transfer heat from evaporator 310 to condenser 320. In one embodiment, working fluid 330 can flow in either direction within capillary tube 302. In one embodiment, capillary tube 302 is configured to allow flow of working fluid 330 in only one direction (indicated by arrows 336), such as by the use of one or more check-valves 338 at suitable locations. As capillary tube 302 undulates between a high temperature in evaporator 310 and a low temperature in condenser 320, heat load Q is transferred from heat source 314 to working fluid 330 in evaporator 310. As heat is transferred to working fluid 330, liquid slugs 332 evaporate, the vapor pressure increases and vapor bubbles 334 in evaporator 310 expand. Expanding vapor bubbles 334 push working fluid 330 toward condenser 320. At the same time, in condenser 320 heat load Q is transferred from working fluid 330 to heat sink 322. As heat load Q is transferred from working fluid 330, vapor bubbles 334 condense. The condensation of vapor bubbles 334 creates a vacuum force that further increases the pressure difference in capillary tube 302 between condenser 320 and evaporator 310, drawing working fluid 330 toward condenser 320. The flow of working fluid 330 from sections of the capillary tube 302 in evaporator 310 toward sections of the capillary tube 302 in condenser 320 also causes the working fluid 330 (liquid slugs 332 and vapor bubbles 334) in the next section to move toward the evaporator 310. Since the pressure differences in capillary tube 302 are completely thermally driven, there is no additional external power is required for circulating working fluid 330.

In one embodiment, pulsating heat pipe 300 is thermally coupled to more than one heat source. Referring to FIG. 2B, first evaporator 310a is coupled to first heat source 314a, and second evaporator 310b is coupled to second heat source 314b. In one embodiment, first heat source 314a comprises illumination source 102, and more particularly reflector 105 of illumination source 102, while second heat source 314b comprises modulation device 114. In other embodiments, additional evaporators coupled to additional heat sources are optionally added to pulsating heat pipe 300.

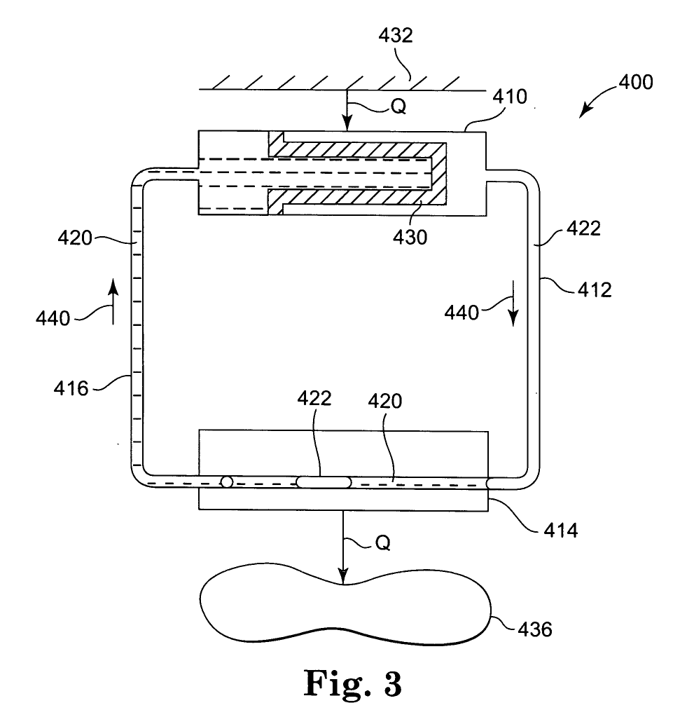

In one embodiment, closed-loop heat pipe 200 comprises a miniature loop heat pipe. Referring to FIG. 3, miniature loop heat pipe 400 includes an evaporator 410, a vapor capillary tube 412, a condenser 414, and a liquid capillary tube 416. Liquid capillary tube 416 is filled with liquid working fluid 420, while vapor capillary tube 412 is filled with vaporous working fluid 422. Evaporator 410 utilizes a porous wick 430 to draw liquid working fluid 420 into evaporator 410 from liquid capillary tube 416. Materials suitable for making wick 430 include sintered metal powders of copper, stainless steel, nickel and titanium, for example. The material of wick 430 is selected for compatibility with working fluid 420. As heat load Q is transferred from heat source 432 to working fluid 420 in evaporator 410, liquid working fluid 420 evaporates. The continued wicking and evaporation of working fluid 420 in evaporator 410 pushes vaporous working fluid 422 through vapor capillary tube 412 toward condenser 414. In condenser 414, heat load Q is transferred from working fluid 420 to heat sink 436 and working fluid 420 condenses to liquid form. Because movement of working fluid 420, 422 is driven in the direction of arrows 440 by wick 430, there is no additional external power required for circulating working fluid 420. Further, wick 430 enables the miniature loop heat pipe 400 to work in any orientation.

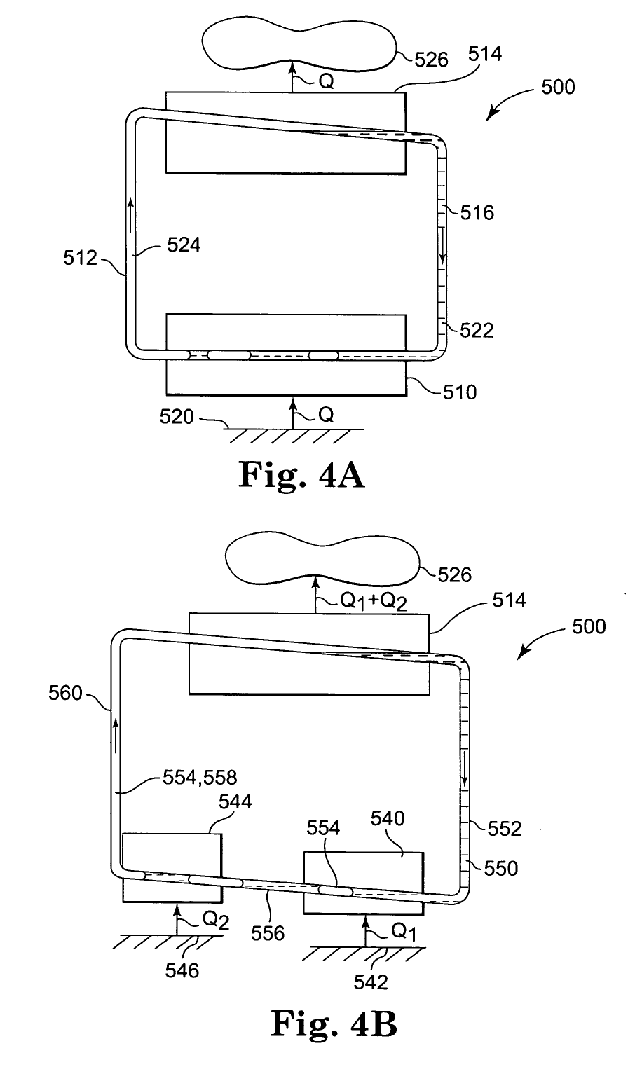

In one embodiment, closed-loop heat pipe 200 comprises a loop thermosiphon. Referring to FIG. 4A, loop thermosiphon 500 includes an evaporator 510, a vapor working fluid tube 512, a condenser 514, and a liquid working fluid tube 516. Heat load Q is transferred from heat source 520 to evaporator 510, where liquid working fluid 522 vaporizes. Vaporized working fluid 524 then moves to condenser 514 through vapor working fluid tube 512, where it condenses and releases heat load Q to heat sink 526. Condensed liquid working fluid 522 from condenser 514 is returned to evaporator 510 through liquid working fluid tube 516, thus completing a closed loop. Condenser 514 is positioned above evaporator 510, such that gravity and the density difference between the liquid working fluid 522 and vapor working fluid 524 creates a pressure head which drives the flow of liquid and vapor through the loop.

In one embodiment, loop thermosiphon 500 is thermally coupled to more than one heat source. Referring to FIG. 4B, first evaporator 540 is coupled to first heat source 542 to receive first heat load Q₁, and second evaporator 544 is coupled to second heat source 546 to receive second heat load Q₂. In one embodiment, first heat source 542 comprises illumination source 102, and more particularly reflector 105 of illumination source 102, while second heat source 546 comprises modulation device 114. In other embodiments, additional evaporators coupled to additional heat sources are optionally be added. A stream of liquid working fluid 550 is received into first evaporator 540 via first tube 552. Heat load Q₁ from first heat source 542 evaporates a portion of the stream of liquid working fluid 550 to form a first stream of working fluid vapor 554. A remaining portion of the stream of liquid working fluid 550 from first evaporator 540 and first stream of working fluid vapor 554 from the first evaporator 540 are intermingled streams, and pass through a second tube 556 to be received in second evaporator 544.

Heat load Q₂ from second heat source 546 evaporates a portion of the remaining stream of liquid working fluid 550 received from second tube 556 to form a second stream of working fluid vapor 558 that intermixes and combines with first stream of working fluid vapor 554 evaporated in first evaporator 540.

The combined first and second streams of working fluid vapor 554, 558, possibly along with the remnants of the stream of liquid working fluid 550 remaining after the second evaporator 544, pass through a third tube 560 to be received by condenser 514. Condenser 514 is configured to dissipate heat load Q₁+Q₂ from the combined first and second streams of working fluid vapors 554, 558 to heat sink 526, and thereby cause the working fluid vapor to condense into liquid working fluid 550. The newly condensed liquid working fluid 550 commingles with remnants (if any) of the prior stream of liquid working fluid received from the third tube 560, adding newly condensed liquid working fluid to form what is effectively the beginning the stream of liquid working fluid 550. The stream of newly condensed liquid working fluid exits the condenser 514 through the first tube 552 and passes back toward the first evaporator 540.

Condenser 514 is configured to define a working fluid pathway that extends in a gravitationally downhill direction from third tube 560 to first tube 552. As a result, the newly condensed liquid working fluid is pulled downhill by gravity, and forces the working fluid stream 550 in first tube 552 to move toward first evaporator 540. The forward moving force of the working fluid stream in first tube 552 is transmitted to the other tubes 556, 560, and as a result, the liquid and vapor working fluid streams are driven through first and second evaporators 540, 544. Because the output from second evaporator 544 is primarily vaporous, the forward moving force on the liquid can preferably drive the output from second evaporator 544 uphill with respect to gravity to reach condenser 514. As a result, loop thermosiphon 500 forms a gravity driven, pumpless, closed loop cooling system that extends through each evaporator in series. In optional operation, the working fluid forms a circular stream that is entirely (or mostly) a liquid working fluid stream in first tube 552, and that is entirely (or mostly) a stream of working fluid vapor in third and final tube 560.

Another embodiment, the mixing of liquid and vapor working fluid could be limited or prevented. More particularly, additional tubes could interconnect first and second evaporators 540, 544 so as to provide separate liquid and vapor working fluid passages between sequential evaporators. In another embodiment, evaporators 540, 544 could be connected between the first tube 552 and last tube 560 in parallel, rather than in series.

Although exemplary embodiments have been illustrated and described herein for purposes of description, it will be appreciated by those of ordinary skill in the art that a wide variety of alternate and/or equivalent implementations may be substituted for the specific embodiments shown and described without departing from the spirit and scope of the present invention. This application is intended to cover any adaptations or variations of the embodiments discussed herein. Therefore, it is manifestly intended that the foregoing discussion is illustrative only, and the invention is limited and defined only by the following claims and the equivalents thereof.

What is claimed is:

1. A projection system comprising:
at least one heat source within the projection system;
a closed-loop heat pipe having at least one heat receiving portion and at least one heat rejecting portion, wherein the at least one heat receiving portion is thermally coupled with the at least one heat source, and wherein the at least one heat rejecting portion is thermally coupled with a heat sink; and
a heat carrying fluid circulating through the heat pipe, the heat carrying fluid receiving heat from the at least one heat source and releasing heat to the heat sink.

2. The projection system of claim 1, wherein the heat pipe is configured to allow flow of the heat carrying fluid through the heat pipe in only one direction.

3. The projection system of claim 1, wherein the heat carrying fluid is a two-phase fluid that vaporizes in the at least one heat receiving portion of the heat pipe, and condenses in the at least one heat rejecting portion of the heat pipe.

4. The projection system of claim 3, wherein the heat carrying fluid is circulated through the heat pipe by vapor pressure forces generated by evaporation in the at least one heat receiving portion and vacuum forces generated by condensation in the at least one heat rejecting portion.

5. The projection system of claim 3, wherein the heat carrying fluid is circulated through the heat pipe at least partially by gravitational forces.

6. The projection system of claim 3, wherein the heat carrying fluid is circulated through the heat pipe at least partially by a wicking structure in the heat pipe.

7. The projection system of claim 1, wherein the at least one heat source comprises at least one of a light source, a reflector, a digital mirror device, and a power source.

8. The projection system of claim 1, wherein the heat sink comprises a chassis of the projection system.

9. A projection system comprising:
a projector component;
an evaporator thermally coupled with the projector component, the evaporator configured to dissipate heat from the projector component by evaporating liquid working fluid from a stream of liquid working fluid to produce a stream of working fluid vapor; and
a condenser configured to dissipate heat from the stream of working fluid vapor to add liquid working fluid to the stream of liquid working fluid.

10. The projection system of claim 9, wherein the evaporator and the condenser are configured as a pumpless, closed-loop cooling system.

11. The projection system of claim 10, wherein the pumpless, closed-loop cooling system is one of a pulsating heat pipe, a loop heat pipe, and a loop thermosiphon.

12. The projection system of claim 9, wherein the stream of liquid working fluid and the stream of working fluid vapor are intermixed.

13. The projection system of claim 9, wherein the stream of liquid working fluid and the stream of working fluid vapor are separated.

14. The projection system of claim 9, wherein the pumpless, closed-loop cooling system is gravity-driven.

15. The projection system of claim 9, wherein the projector component comprises an imaging system component.

16. The projection system of claim 15, wherein the imaging system component comprises at least one of a light source, a reflector, and a digital mirror device.

17. The projection system of claim 9, further comprising an air mover configured to cool the condenser.

18. The projection system of claim 9, further comprising:
a second projector component;
a second evaporator thermally coupled with the second projector component, the evaporator configured to dissipate heat from the second projector component by evaporating liquid working fluid from the stream of liquid working fluid to produce a second stream of working fluid vapor;
wherein the condenser is configured to dissipate heat from the second stream of working fluid vapor to add liquid working fluid to the steam of liquid working fluid.

19. The projection system of claim 9, further comprising:
a second projector component;
a second evaporator thermally coupled with the second projector component, the evaporator configured to dissipate heat from the second projector component by evaporating liquid working fluid from a second stream of liquid working fluid to produce a second stream of working fluid vapor; and
a second condenser configured to dissipate heat from the second stream of working fluid vapor to add liquid working fluid to the second stream of liquid working fluid.

20. The projection system of claim 9, wherein the condenser is configured to transfer heat from the stream of working fluid vapor to a chassis of the projection system.

21. The projection system of claim 9, wherein the condenser is configured to transfer heat from the stream of working fluid vapor to the environment.

22. The projection system of claim 9, wherein the condenser is positioned inside a chassis of the projection system.

23. The projection system of claim 9, wherein the condenser is positioned outside of a chassis of the projection system.

24. A projection system comprising:
a projector component;
a means for evaporating liquid working fluid from a stream of liquid working fluid, using heat from the projector component, to produce a stream of working fluid vapor; and
a means for removing heat from the stream of working fluid vapor.

25. The projection system of claim 24, further comprising means for transferring the removed heat to the environment.

26. The projection system of claim 24, further comprising means for transferring the removed heat to a chassis of the projection system.

27. A method for cooling a projection system, comprising:
evaporating liquid working fluid from a stream of liquid working fluid, using heat from the projector component, to produce a stream of working fluid vapor; and
removing heat from the stream of working fluid vapor.

28. The method of claim 27, further comprising transferring the removed heat to the environment.

29. The method of claim 27, further comprising transferring the removed heat to a chassis of the projection system.
